(19) United States
(12) Patent Application Publication
(10) Pub. No.: US 2007/0263267 A1
(43) Pub. Date: Nov. 15, 2007

(54) Method for the positionally correct assignment of two medical image data records of an object

(76) Inventor: Hendrik Ditt, Numberg (DE)

Correspondence Address: HARNESS, DICKEY & PIERCE, P.L.C., P.O.BOX 8910, RESTON, VA, 20195, US

(21) Appl. No.: 11/634,147

(22) Filed: Dec. 6, 2006

(30) Foreign Application Priority Data
Dec. 7, 2005 (DE) 10 2005 058 480.2

(51) Int. Cl. H04N 1/46

(52) U.S. Cl. 358/540

(57) ABSTRACT

A method for the positionally correct assignment of two medical image data records of an object is disclosed. In at least one embodiment of the method, at least two partial regions corresponding with respect to the object are respectively selected in the two image data records. Further, a local measure is determined in each partial region for the positional deviation of the two image data records. Finally, the two image data records in the partial region are displaced rigidly relative to one another for each partial region whose local measure exceeds a local limit value.

### PRIORITY STATEMENT

The present application hereby claims priority under 35 U.S.C. §119 on German patent application number DE 10 2005 058 480.2 filed Dec. 7, 2005, the entire contents of which is hereby incorporated herein by reference.

### FIELD

The Embodiments of the invention generally relate to a method for the positionally correct assignment of two medical image data records of an object.

### BACKGROUND

The purpose of medical imaging as a rule is to prepare images of the interior of a patient, for example a living human or animal. The aim in this case is generally to provide a pictorial display of a specific object inside the patient. Such an object can be, for example, an internal organ, a bone structure or a tissue structure of the patient. Nowadays, the image of the object is generally stored as a digital image data record, since all the imaging is generally formed digitally. The method described below can, of course, be applied correspondingly to analog images. The method can be used both for 2D images and for 3D image data records.

A number of image data records are often produced of one and the same object in a patient. Pictures of the object are taken, for example, at different instances, for example, during a diagnosis and during a treatment, that is to say in a manner offset by a number of days or weeks. Image data are also obtained with the aid of two different medical modalities, that is to say imaging units. Some medical imaging methods generally require a number of image data records to be recorded. Thus, two 3D CT pictures of image data records are prepared, once with and once without contrast agent in the patient, in order, for example, to represent a patient's vessel trees. The two image data records are subsequently subtracted from one another. In the ideal case, the two differ from one another only through the patient's vessels filled with contrast agent. These remain as the only image data after the subtraction.

Two medical image data records must be assigned to one another with positional correctness in order to be able, in general, to compare them effectively with one another. That is to say, the positional coordinates of the object represented in the two image data records are the same in both, that is to say in other words the imaged objects are displayed congruently. Only thus is it possible to carry out an exact subtraction of the two image data records in the example set forth above.

The positionally correct assignment is also denoted as registration. The following problems now occur in the registration of two image data records of a patient:

A) The person or the object to be imaged can move in the period between the preparation of the two image data records. The object imaged in the image data record is then mostly displaced by translation or rotated.

B) The object can move during the preparation of a single image data record. As a result, the object appears, for example, to be distorted, shifted or non-uniform.

C) The position of tissue, bones or organs can change relative to one another. If, for example, the patient opens his jaw while having his head imaged, this varies the position of the jawbone relative to the cranial bone. Surrounding tissue is also displaced in this case.

All these effects lead to an unsatisfactory registration, since the position and/or structure of the object represented in the two image data records deviate from one another.

Various approaches are known so far for solving this set of problems. In the simplest case, the two image data records are displaced rigidly relative to one another, for example until a positionally correct matching is achieved for the largest part of the image content. In this context, rigid displacement means that only translational movements and rotations of the image content are carried out, but that no deformation such as elongation, bending etc. of the image content takes place. However, only movements in accordance with A), that is to say of the object in its entirety between the two image data records, can be compensated by means of such a rigid displacement.

In the case of 3D image data records that are obtained in slice-wise fashion in scanning operations, interference in accordance with B) frequently occurs when the patient moves after half the scan, for example. The image contents are then displaced in the further progress of the scan. It is known to this end to register each layer or each tomogram of an image data record individually in two or three dimensions with a tomogram, corresponding thereto, of another image data record (van Straten et al., “Removal of bone in CT angiography of the cervical arteries by piecewise matched mask bone elimination”, Med. Phys. 31 (10), October 2004).

The abovementioned relative displacements in accordance with C) between image data records cannot be compensated using any of the abovementioned methods. This is because the previously known methods operate by being image-oriented. However, this succeeds, for example, by orienting on the imaged object itself, that is to say by registering each imaged bone of the patient individually.

However, this method requires segmentation, in other words individual identification of each individual bone, that is to say of each inherently individually rigid, but movable part of the patient or object. Each of these objects is then inherently not deformable and can therefore be assigned correctly by means of rigid registration (van Straten et al., “Removal of bone in CT angiography of the cervical arteries by piecewise matched mask bone elimination”, Med. Phys. 31 (10), October 2004). The segmentation per se, which requires substantially outlay or intervention by the user, is problematical here. Artifacts in imaging can even render such a correct segmentation of bones impossible. For example, on account of radiation scattered at a dental implant, image information in the surroundings thereof is overlaid thereby in the case of CT pictures, for example, and so it is no longer possible to distinguish between a jawbone and cranial bone. Thus, it is often generally impossible for all the individual bone parts to be segmented, and for these to be respectively registered per se against one another.

There is the problem that the approaches to a solution which have just been mentioned cannot be combined with one another at will for the problems described under points A) to C). The registration of individual layers in order to compensate a movement in accordance with B) can, for example, not be combined with the segmentation of bones (movement C)). Specifically, following a different registration of layers, bones, for example, are deformed in the image data or no longer represented coherently, and so the layer position need no longer be unique.

If, by contrast, a bone segmentation is firstly carried out for the compensation of C), individual tomograms, for example, are displaced relative to one another in the two image data records such that the latter can no longer be registered layer for layer in order to compensate the movement B).

### SUMMARY

In at least one embodiment of the present invention, an improved method is specified for the positionally correct assignment of two medical image data records of an object.

A method, in at least one embodiment, is for the positionally correct assignment of two medical image data records of an object, in which a) at least two partial regions corresponding with respect to the object are respectively selected in the two image data records. Here, the regions are generally selected automatically. The regions are then not determined: they determine themselves, as it were, by way of regions not yet satisfactorily registered (see below). Consequently, the individual unregistered regions are not depicted or the like, but are determined automatically by way of an error deviation A (see below). Regions that are found are re-registered rigidly, in the hope of correctly registering parts thereof, while other parts thereof can, in turn, still be wrongly registered.

This method, in at least one embodiment, is executed repeatedly in sequence until all the regions are correctly registered. In other words, partial regions corresponding with reference to the object are respective regions of the image data records that include mutually corresponding views, cutouts, details etc. of the object. In method step b), a local measure of the positional deviation of the two image data records is determined in each particular region. In other words, the local measure is a parameter that, for each partial region, specifies how well these partial regions are assigned, with positional correctness, to one another in the two image data records. A local measure of, for example, zero then means that the two image data records correspond pixel for pixel (or voxel for voxel in the 3D case) to the same point of the object represented, that is to say respectively represent or imaged this point.

In method step c), for each partial region whose local measure exceeds a local limit value, the two image data records are displaced rigidly relative to one another in the partial region. Thus, in other words if the positionally correct matching of the image contents is not yet satisfactory, which means for example, that the local limit value is being undershot, the positional assignment of the two image data records must be corrected in the partial region. Consequently, the corresponding partial regions of the image data are rigidly displaced relative to one another.

At least one embodiment of the invention is based on the idea of carrying out the positionally correct assignment, that is to say registration solely by way of rigid registration, that is to say rigid, non-deformable displacement of the image data records, thus the image contents, in relation to one another. At least one embodiment of the invention is further based on the finding that a rigid registration of the two image data records in their entirety has so far always supplied the best possible results for a portion of the image data record, while other regions of the image data record have been registered poorly or unsatisfactorily.

Consequently, at least one embodiment of the invention is based, furthermore, on the idea of marking or selecting only portions of the image data records, that is to say specific partial regions, that are not yet satisfactorily registered, and rigidly registering these partial regions separately in relation to one another, that is to say for themselves, in subsequent steps. The residual image content remains here in an unchanged positional assignment, and is therefore not concomitently displaced. It is thereby avoided that a first location or a region of the image data that is already assigned with adequate positional correctness is concomitently displaced again by displacement of the total image content because of adaptation of a second image region, and that, as a result, while the positional assignment is certainly improved at this second location, it is worsened again at the first location.

Consequently, according to at least one embodiment of the invention, at least two partial regions are respectively selected in the two image data records. The displacement of the image data records in the partial regions generally takes place independently of one another, each partial region being rigidly displaced independently.

It is only in the respective partial region that the local measure is determined for the positional deviation of the two image data records. Thus, it is established in each partial region whether the latter has already been satisfactorily registered or how well it is registered.

The formation of partial regions can be performed differently in various steps, that is to say partial regions can be newly selected several times. The rigid displacement in a single partial region is carried out as a rule until the local measure there is minimal, that is to say the optimal local assignment for the partial region is achieved. For example, to this end the local measure is continuously controlled and formed continuously or repeatedly anew during the stepwise or continuous displacement.

In the method according to at least one embodiment of the invention, there is thus no need for segmenting bones or other structures in the image data. Even, regions such as bones, for example, which can be segmented only with difficulty can be correctly registered.

In the case of 3D image data that are based on tomograms, there is likewise no kind of need for the individual tomograms to be registered. By contrast with a deforming displacement, a rigid displacement can be carried out particularly easily and quickly, that is to say with little computational outlay, in the 2D and also in the 3D case.

Owing to the splitting into partial regions, it is only the image components which have not yet been registered adequately or satisfactorily that are further processed. Once it has been found, a registration between the two image detail records is therefore no longer lost for partial regions already correctly assigned.

The method according to at least one embodiment of the invention can be used to correct the entire above-named movement A) to C) of an object between the preparation of two medical data records.

The present method, in at least one embodiment, supplies a particularly good positionally correct assignment for bones, in particular, which really are rigid objects and can therefore accomplish only translational and rotary movements (rigid movements) between the recording of two image digital records, this being so because the solely rigid displacement of the image contents causes no kind of deformations of the image contents, something which can be of no use in the case of bones, since these cannot be deformed in reality.

In the case of deformation registration, a reduction in resolution is often carried out in the image data record in order to be able at all to handle the amount of data computationally with the aid of a deformation algorithm. The method according to at least one embodiment of the invention can be applied to the whole image data record in its full resolution and amount of data: there is no need for data reduction since, as mentioned above, the rigid displacement does not place stringent requirements on appropriate hardware with regard either to memory or to computing power.

In addition to the local measure, it is possible to determine a total measure for the positional deviation of the two image data records in their entirety relative to one another. The method steps A) to C) can then be repeated until the total measure is smaller than a total limit value, that is to say, in other words, the two total image data records are registered as desired. Here, as desired means, for example, that the total measure drops below the previously fixed total limit value.

As a result, all the image data records really are assigned to one another in the positionally correct position to the desired extent, and it is not the case that, owing to an unskillful division of the region, the partial regions are registered as desired, but not the total image.

The two image data records can be displaced rigidly relative to one another in their entirety. This, as well, is generally carried out until or such that as good as possible matching is achieved for the two image data records in their entirety, that is to say the total measure is minimal. Such a method step can be performed at the beginning of the method, that is to say even before forming the partial regions, in order to achieve, in advance, an at least coarsely positionally correct assignment for a majority of the image regions.

Only a few or small partial regions may then need to be formed and, further, displaced relative to one another, something which therefore corresponds to a fine adjustment of the image data records already assigned with coarse positional correctness.

A number of possibilities are conceivable on their own or in combination as measures for the positionally correct assignment of image data records relative to one another.

Thus, the total measure and/or the local measure can be the difference between corresponding pixels of the two image data records. Forming the difference gives rise as total measure and/or local measure to an image of value zero at each pixel or voxel for ideally matching, corresponding image data records. A difference image is thus produced pixel by pixel, for example. Such difference images are displayed, for example, on a screen in such a way that a pixel value of zero is displayed with an average grayscale value, and positive values are displayed in a darker way or negative ones in a brighter way. Thus, a uniformly grey image results for ideally matching image data records. Deviations in the two images can be perceived particularly easily by the human eye as darker or brighter locations deviating therefrom.

However, measures can also be determined and evaluated purely numerically, for example in the form of statistical variables such as mean, variance or the like.

A number of possibilities exist also for evaluating the rigid registration, that is to say rigid displacement of the image data records.

The rigid displacement of the image detail records can, for example, be carried out using a mutual information algorithm or sum of squared differences algorithm.

In specific instances, it is possible, in turn, for there to exist in the image data records or partial regions subregions that, as is known, cannot be brought into congruence. For example, a vessel tree is present in a contrast agent picture as first image data record, while not being visible in a regular CT image without contrast agent of the same patient. The vessel tree in the first image therefore does not, as is known, have a counterpart in the CT image.

The total measure and/or local measure can therefore be determined only for a subregion of the image data records or partial regions. The subregion is, for example, the entire portion of the image data record or partial region with the exception of the structures that are, as is known, not to be brought into congruence.

The regions that, as is known, cannot be brought into congruence are therefore capable of being excluded from the formation of the total measure or local measure. Such regions thus, for example, do not falsify the measures for the local matching which should, for example, ideally supply a value of zero in the event of identical coverage.

It is also possible to select as subregion only the region of the image data record or partial region that is assigned to specific object structures of the imaged object.

By contrast with the above, the subregion is then selected to be yet narrower, specifically such that not only specific regions of the image data record are masked out, but only the subregions of interest in the image data records that are to be brought into congruence are at all considered.

As a result, the method according to at least one embodiment of the invention registers as subregions of the image data records only objects that can actually be detected effectively, for example. This is sensible, in particular, when the object structure is a bone and/or its surroundings. As already mentioned above, the particularly good rigid registration is possible for bones as object structures on the basis of their rigid physical nature. No account is taken of surrounding tissue or the like, for example, when forming the measures.

In addition, prior knowledge of the imaged object can be used to carry out at least one embodiment of the invention. Thus, a number of partial regions of the image data records that belong to a rigidly coherent object structure of the imaged object can be displaced rigidly in dependence on one another. For example, an object rigidly coherent per se in three dimensions can be imaged in a 2D image at two partial regions isolated from one another. Only a common displacement of the two apparently isolated image contents therefore corresponds to an actually possible movement of the object between two pictures.

Thus, for example, two partial regions in a 2D image that display the section through a U-shaped bone such as the jawbone can be displaced in dependence on one another, and thus rigidly in three dimensions relative to one another—since these belong to the same real rigid object.

### BRIEF DESCRIPTION OF THE DRAWINGS

Reference is made to the example embodiments of the drawings for a further description of the invention. In a respective schematic sketch of the drawings:

FIG. 1 shows a) a first CT image of a patient's head, and b) shows a second CT image of the same patient recorded at a later point in time after the patient has moved,

FIG. 2 shows the difference image of the unregistered X-ray images from FIG. 1,

FIG. 3 shows an image in accordance with FIG. 2 after a rigid total displacement of the X-ray images from FIG. 1 and the formation of partial regions,

FIG. 4 shows an image in accordance with FIG. 2 after a displacement in a first subregion, and

FIG. 5 shows the same in a second subregion,

FIG. 6 shows a real difference image in accordance with FIG. 2 with a vessel tree and movement artifacts, and

FIG. 7 shows the image in accordance with FIG. 6 after correction with the aid of the method according to an embodiment of the invention.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

By contrast with an X-ray image, which displays a transillumination of the patient, a CT image constitutes a slice-wise display of the patient. In the example, it is not the axial images actually recorded that are viewed, but a reformatting in the sagital or coronal direction.

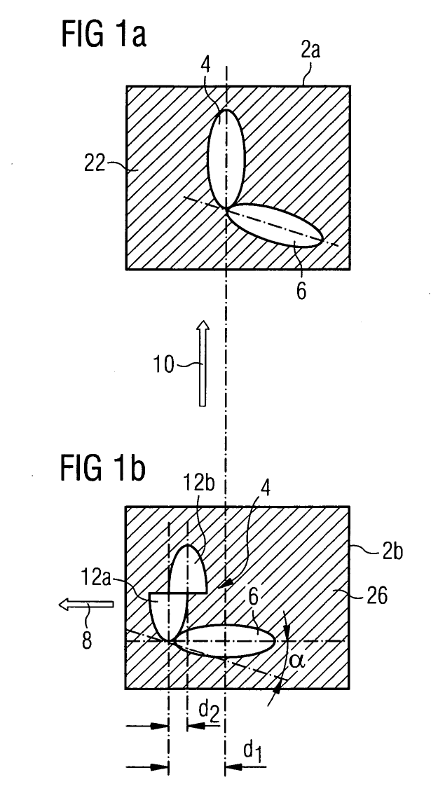

FIG. 1a shows a first CT image 2a that was recorded at a first point in time from a patient who is not illustrated. Both the cranium 4 and the lower jawbone 6 of the patient are visible in the CT image 2a. FIG. 1b shows a CT image 2b of the same patient that was recorded at a later point in time. The CT images 2a, b were prepared in the course of applying 3D computer tomography to image the patient in a slice-wise fashion in the direction of the arrow 10.

The patient performed various movements relative to the X-ray unit between the recording of the two X-ray images 2a, b, and for this reason he appears at another location or in another display in the X-ray image 2b. The patient has moved his entire head between the preparation of the two X-ray images 2a, b by the distance d₁ in the direction of the arrow 8. This corresponds to the above cited movement A). Furthermore, the patient has tilted his lower jawbone 6 upward relative to the cranium 4 by the angle a. This corresponds to the abovementioned movement in accordance with C).

During the preparation of the CT images in the direction of the arrow 10, the patient has moved by an amount d₂ counter to the direction of the arrow 8. Consequently, the lower part 12a of the cranium 4 is imaged in the CT image 2b at an earlier point in time than the upper part 12b), and therefore in offset fashion.

Consequently, by comparison with the X-ray image 2a the X-ray image 2b exhibits an overall movement A), a movement during the image recording B), and a structural change C) on the part of the patient.

The objects displayed in the X-ray images 2a, b appear white (grayscale value 128) in front of a middle grey background (grayscale value 0), this being illustrated in the drawings by hatched areas.

The aim below is for a doctor (not illustrated) to evaluate and compare the two X-ray images 2a, b. To this end, he would like to display the image contents in as congruent a way as possible, in order to be able to find the changes more easily. The two X-ray images 2a, b are subtracted from one another in order to assign them with positional correctness.

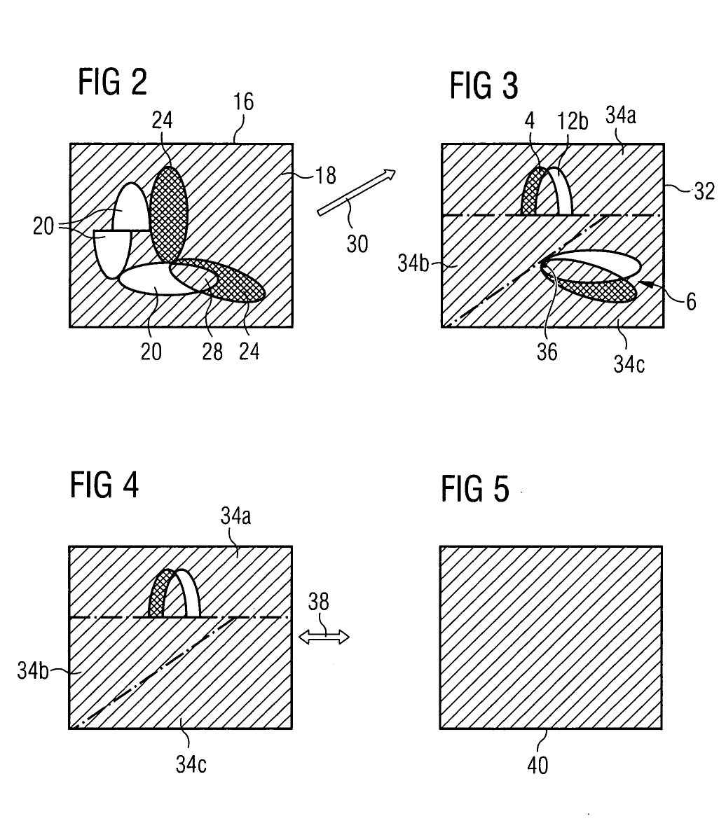

FIG. 2 shows a subtraction image 16, in the case of which the CT image 2a has been subtracted pixel for pixel from the CT image 2b. In the region 18, the CT images 2a and 2b match one another with reference to their grayscale values, for which reason the difference image there has the grayscale value zero, and this, in turn, corresponds to a medium gray, coloring in the difference image 18. The region 20 (brighter than the region 18) originates from the CT image 2b since, in the corresponding regions, the cranium 4 and lower jawbone 6 in the CT image 2b exhibit higher grayscale values 128 than the surroundings 22 (grayscale value 0) in the X-ray image 2a.

The cranium and lower jawbone 6, in turn, remain from the CT image 2a as a dark region 24 (grayscale value −128), since larger brightness values (128) are subtracted from the grayscale value of the surroundings 26 (0) in the CT image 2b, and this leads to the brightness value −128 in the region 24 in FIG. 2 (black, represented by hatching). It is only in the region 28 that a partial covering of the lower jawbone 6 of the CT images 2a, b takes place, and for this reason a subtraction value 0, and thus a mean grayscale value as in the region 18 likewise occurs there.

$$Δ = {\sum }_{allpixels} \vert grayscale {value}_{a} - grayscale {value}_{b} \vert ,$$

the sum all pixels of the absolute grayscale value differences of all the pixels, is formed in FIG. 2 as the deviation measure A for the matching of the CT images 2a, b with respect to their positionally correct assignment. The sum supplies a value of 100 in the example of FIG. 2, for example.

Since at most a deviation with a total limit value of G=10 is tolerated for the positional assignment of the two CT images 2a, b, there is a need for registration, that is to say relative displacement of the image contents of the CT images 2a, b, with respect to one another.

The CT image 2b is therefore displaced as a whole with reference to the CT image 2a in the direction of arrow 30. Subsequently, as already explained in conjunction with FIG. 2, a new subtraction image 32, which is demonstrated in FIG. 3, is prepared. The lower part 12a of the cranium 4 is now brought into congruence between the X-ray images 2a, b, and for this reason no longer appears in the difference image 32. All that still remains to detect is the displaced upper part 12b of the CT image 2b by comparison with the rest of the cranium 4 from CT image 2a, as well as the regions of the lower jawbone 6, which are displaced one from another by the angle α.

A further rigid displacement of the image contents of the CT images 2a, b would certainly lead to congruence here, but the lower part 12a would likewise be pushed out of its meanwhile matching position. This is not desirable.

The CT images 2a, b are therefore divided into corresponding partial regions 34a-c, each partial region corresponding to the same object structure of the patient. Thus, the partial region 34a respectively includes the upper part 12b of the cranium 4 in both CT images 2a, b. The partial region 34c includes the lower jawbone 6 in each case.

A corresponding deviation measure Δₐ to Δ_{c} is determined in accordance with the above rule for each of these partial regions. Since the two CT images 2a, b match identically in the partial region 34b, the measure Δ_{b}=0. By contrast, deviations Δₐ=30 and Δ_{c}=40 exist for the regions 34a and c, that is to say likewise still deviations above tolerated local limit values Gₐ=G_{b}=G_{c}=10.

Consequently, in a further step, the partial regions 34c in the two CT images 2a, b are mutually rotated rigidly by the angle a with reference to the centre of rotation 36. The lower jawbone 6 of the two CT images 2a, b are thus rendered congruent. As a result, a difference image is then produced in accordance with the procedure in FIG. 2, and is illustrated in FIG. 4. The partial region 34c is also now correctly registered, that is to say the deviation measure Δ_{c}=0. The two other partial regions 34a, b remain unchanged and thus so do their deviation measures.

In a concluding step, the partial region 34a in which the CT images 2a, b in the corresponding partial region are displaced rigidly relative to one another in the direction of the arrow 38 is also registered.

FIG. 5 shows the final subtraction image 40, which is uniformly medium grey with a grayscale value of 0. The deviation measure Δ=0, that is to say the CT images 2a, b are assigned to one another with positional correctness by carrying out operations appropriately.

The doctor can now easily compare the CT images. In addition, it is now possible to carry out further image processing operations on the CT images 2a, b assigned in such a way with positional correctness.

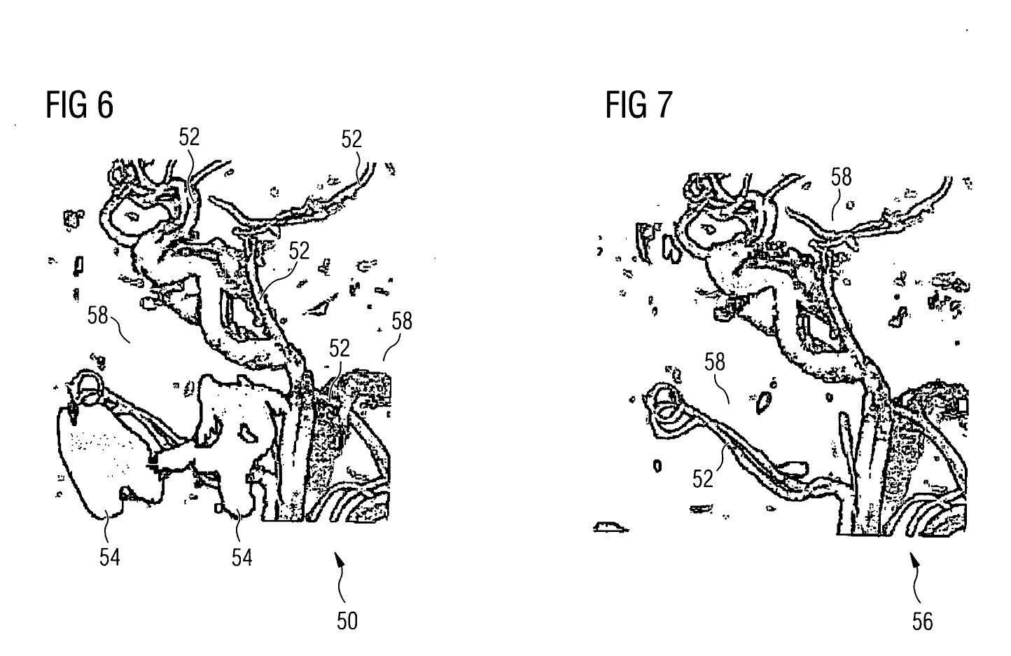

By contrast with the previous example of the principle, FIG. 6 shows a real difference image 50 of a patient in a fluoroscopic display (MIP, Maximum Intensity Projection) to which a contrast agent was administered. A picture of the patient was taken in this case in accordance with the first CT image 2a from FIG. 1. In accordance with the second CT image 2b from FIG. 1, a CT image that visualizes vessels 52 of the patient in the CT image is additionally produced with the administration of contrast agent.

However, since the patient (not illustrated) has moved the joint of his jaw 54, as likewise illustrated in FIG. 1, between this picture and the picture of the corresponding reference image without contrast agent, said joint does not disappear in the corresponding preparation of the difference image 50, and is thus visible in FIG. 6. The vessel tree 52 does not disappear, in any case, since it has no corresponding counterpart in the first X-ray image. Exactly this is desired.

FIG. 7 shows a difference image 56 in a fluoroscopic display (MIP), which was produced on the same initial images, that is to say CT images, as for the difference image 50, but using the method according to an embodiment of the invention. Owing to the corresponding registration by region, it was also possible for the jaw joint 54 to be assigned with positional correctness in the two initial CT images, specifically those prepared with and without contrast agent, such that it disappears in the difference image 56. Of course, the patient's vessels 52 remain as before, but are now also to be seen in the region in which they were covered in FIG. 6 by the jaw joint 54.

Since, in the case of the medical method, there is nothing corresponding in the first CT image to the vessel tree 52 from the second one, the corresponding local measures and the total measure G in FIG. 6 and FIG. 7 are formed only in a subregion 58, specifically the total image without the vessel tree 52.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for the positionally correct assignment of two medical image data records of an object, comprising:
respectively selecting at least two partial regions corresponding with respect to the object in the two image medical data records;
determining a local measure in each partial region for a positional deviation of the two image medical data records; and
displacing the two image data records, in the partial region, rigidly relative to one another for each partial region whose local measure exceeds a local limit value.

2. The method as claimed in claim 1, wherein a total measure for the positional deviation of the two image data records is determined, and the method steps of respectively selecting and displacing are repeated until the total measure is smaller than a total limit value.

3. The method as claimed in claim 2, wherein the two image data records are displaced rigidly relative to one another.

4. The method as claimed in claim 2, wherein at least one of the total measure and the local measure is the difference between corresponding pixels of the image data two records.

5. The method as claimed in claim 1, wherein the rigid displacement of the image data records is carried out with the aid of at least one of a mutual information algorithm and a sum of squared differences algorithm.

6. The method as claimed in claim 2, wherein at least one of the total measure and the local measure is determined only for at least one of a subregion of the image data records and partial regions.

7. The method as claimed in claim 6, wherein at least one of the region of the image data record and partial region that is assigned to specific object structures of the imaged object is selected as subregion.

8. The method as claimed in claim 7, wherein the object structure is at least one of a bone and its surroundings.

9. The method as claimed in claim 1, wherein a number of partial regions of the image data records that belong to a rigidly coherent object structure of the imaged object are displaced rigidly in dependence on one another.

10. The method as claimed in claim 2, wherein a number of partial regions of the image data records that belong to a rigidly coherent object structure of the imaged object are displaced rigidly in dependence on one another.

11. A computer readable medium including program segments for, when executed on a computer device, causing the computer device to implement the method of claim 1.

12. A computer readable medium including program segments for, when executed on a computer device, causing the computer device to implement the method of claim 2.

13. A system for the positionally correct assignment of two medical image data records of an object, comprising:
means for respectively selecting at least two partial regions corresponding with respect to the object in the two image medical data records;
means for determining a local measure in each partial region for a positional deviation of the two image medical data records; and
means for displacing the two image data records, in the partial region, rigidly relative to one another for each partial region whose local measure exceeds a local limit value.

14. The system as claimed in claim 13, wherein a total measure for the positional deviation of the two image data records is determined, and the respectively selecting and displacing are repeated until the total measure is smaller than a total limit value.

15. The system as claimed in claim 14, wherein the two image data records are displaced rigidly relative to one another.

16. The system as claimed in claim 14, wherein at least one of the total measure and the local measure is the difference between corresponding pixels of the image data two records.

17. The method as claimed in claim 13, wherein the rigid displacement of the image data records is carried out with the aid of at least one of a mutual information algorithm and a sum of squared differences algorithm.
